(19) United States
(12) Patent Application Publication
(10) Pub. No.: US 2002/0032828 A1
(43) Pub. Date: Mar. 14, 2002

(54) Seamless defect management conversion

(75) Inventor: Edward Sean Hoskins, Longmont, CO (US)

Correspondence Address: Merchant & Gould P.C., P.O. Box 2903, Minneapolis, MN, 55402-0903, US

(73) Assignee: Seagate Technology, LLC

(21) Appl. No.: 09/853,565

(22) Filed: Sep. 4, 2001

Related U.S. Application Data
(60) Provisional application No. 60/202,889, filed on May 10, 2000.

(51) Int. Cl. G06F 12/10

(52) U.S. Cl. 711/4; 711/203; 714/8

(57) ABSTRACT

Methods and associated apparatus are disclosed that convert a logical block address value for a data storage disc location to a physical cylinder, physical head, and the physical sector or logical sector. The method and associated apparatus permit the spare sectors to be pooled at the end of the disc drive's volume, if desired, rather than always being included on each track. The methods and apparatus involve computing parameters and/or looking up parameters in a defect list stored in memory. Various steps are involved such as finding a target physical block address from a number of slipped (i.e., defective) sectors, finding an offset into the zone of interest, finding an offset into the track of interest, and finding a total cylinder and head skew up to the target physical block address.

However, for many applications involving time-critical data, such as with audio/visual data, it is desirable to use a seamless defect management. With seamless defect management, the spares are pooled together at the end of the disc's volume (i.e., spares occupy a set of tracks) rather than having a set number of spares at the end of each track. Pooling spares at the end of the volume allows data to be written to or read from tracks having no spares so that time is not wasted skipping over any unused spares in those tracks. The seamless defect management results in tracks having varying numbers of sectors that are used because the number of unused defective sectors varies per track. The varying number of used sectors per track precludes the normal implementation of conventional hardware configured to operate as a track-based defect management system.

Accordingly there is a need for a method of converting a logical location to a physical location on the data storage disc of a conventional disc drive that permits use of seamless sparing schemes if desired.

### SUMMARY OF THE INVENTION

Against this backdrop the present invention has been developed. The present invention provides a translation of an LBA to a physical location on the data storage disc of the disc drive. A physical cylinder, physical head, and a physical sector or logical sector may be determined from the LBA and may be used to properly position the head of the disc drive over the correct location on the data storage disc.

The present invention may be embodied in a method for translating a target logical block address (TLBA) value to a physical location value on a data storage disc of a disc drive. The method involves finding a target physical block address (TPBA) value corresponding to the TLBA value. A track offset value of the TPBA value from a start of a zone containing a target PBA corresponding to the TPBA value is determined. A physical cylinder value is computed from the track offset value, and a physical head value is computed from the track offset value. A total skew value is determined and a PBA offset value of the TPBA value is determined as well. After determining the total skew, a physical sector value is computed from the total skew value as well as from the PBA offset value that was also determined.

The present invention may also be embodied in a disc drive that translates a TLBA value to a physical location value on a data storage disc. The disc drive includes an interface for receiving a command from a host computer. The disc drive further includes a processor configured to find a TPBA for the command, determine a track offset value of the TPBA value from a start of a zone containing a TPBA corresponding to the TPBA value, compute a physical cylinder value and a head value from the track offset value, find a track start LBA (TSLBA) value for the target PBA value, and compute a logical sector value from the track start LBA value and the TLBA value.

These and various other features as well as advantages which characterize the present invention will be apparent from a reading of the following detailed description and a review of the associated drawings.

### BRIEF DESCRIPTION OF THE DRAWINGS

FIG. 1 is a plan view of a disc drive incorporating a preferred embodiment of the present invention showing the primary internal components.

FIG. 2 is a functional block diagram of a disc drive control system for the disc drive shown in FIG. 1 incorporating the present invention.

FIG. 3 is a flow diagram of the defect conversion for detecting the physical location on the disc corresponding to a logical block address.

### DETAILED DESCRIPTION

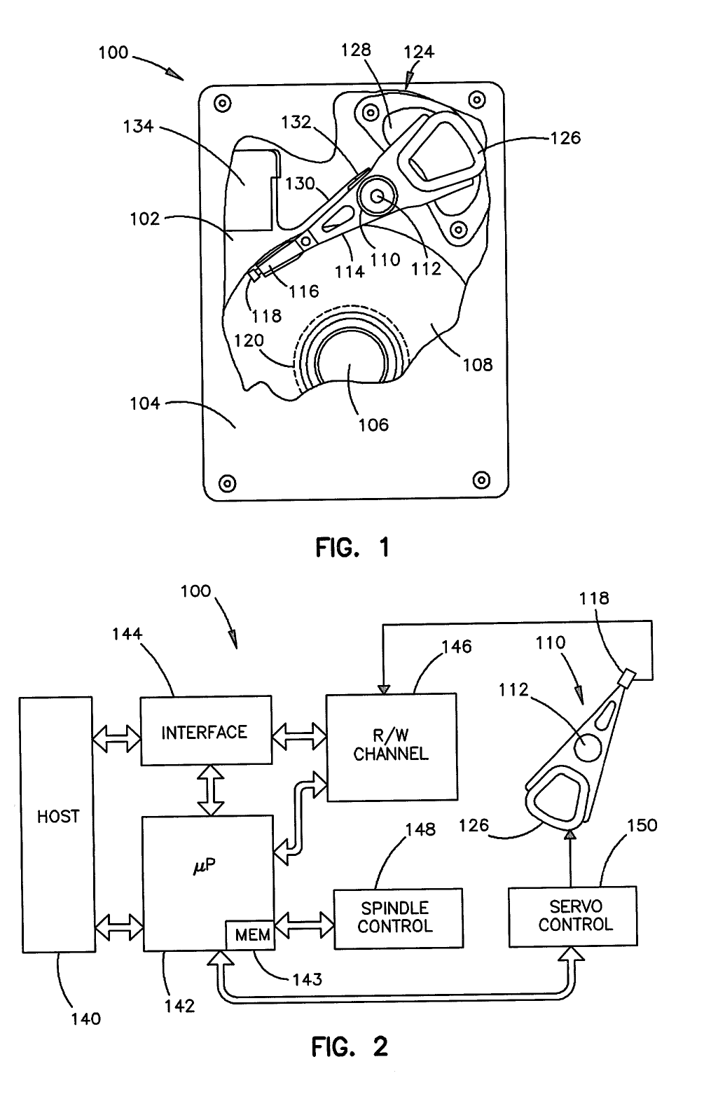

A disc drive 100 constructed in accordance with a preferred embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive 100 in a conventional manner. The components include a spindle motor 106 which rotates one or more discs 108 at a constant high speed. Information is written to and read from tracks on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a transducer head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are typically moved over park zones 120 near the inner diameter of the discs 108 when the drive motor 106 is de-energized. The heads 118 are secured over the park zones 120 through the use of an actuator latch arrangement, which prevents inadvertent rotation of the actuator assembly 110 when the heads 118 are parked.

A flex assembly 130 provides the requisite electrical connection paths for the actuator assembly 110 while allowing pivotal movement of the actuator assembly 110 during operation. The flex assembly 130 includes a preamplifier printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly 130 terminates at a flex bracket 134 for communication through the base deck 102 to a disc drive printed circuit board (not shown) mounted to the bottom side of the disc drive 100.

Referring now to FIG. 2, shown therein is a functional block diagram of the disc drive 100 of FIG. 1, generally showing the main functional circuits which are resident on the disc drive printed circuit board (not shown) and used to control the operation of the disc drive 100. The disc drive 100 is operably connected to a host computer 140 in a conventional manner. Control communication paths are provided between the host computer 140 and a disc drive microprocessor 142, the microprocessor 142 generally providing top level communication and control for the disc drive 100 in conjunction with programming for the microprocessor 142 stored in microprocessor memory (MEM) 143. The MEM 143 can include random access memory (RAM), read only memory (ROM) and other sources of resident memory for the microprocessor 142.

The discs 108 are rotated at a constant high speed by a spindle motor control circuit 148, which typically electrically commutates the spindle motor 106 (FIG. 1) through the use of back electromotive force (BEMF) sensing. During a seek operation, wherein the actuator 110 moves the head 118 between tracks, the position of the heads 118 is controlled through the application of current to the coil 126 of the voice coil motor 124. A servo control circuit 150 provides such control. During a seek operation the microprocessor 142 receives information regarding the velocity of the head 118, and uses that information in conjunction with a velocity profile stored in memory 143 to communicate with the servo control circuit 150, which will apply a controlled amount of current to the voice coil motor coil 126, thereby causing the actuator assembly 110 to be pivoted.

Data is transferred between the host computer 140 and the disc drive 100 by way of an interface 144, which typically includes a buffer to facilitate high speed data transfer between the host computer 140 and the disc drive 100. Data to be written to the disc drive 100 is thus passed from the host computer to the interface 144 and then to a read/write channel 146, which encodes and serializes the data and provides the requisite write current signals to the heads 118. To retrieve data that has been previously stored by the disc drive 100, read signals are generated by the heads 118 and provided to the read/write channel 146, which performs decoding and error detection and correction operations and outputs the retrieved data to the interface 144 for subsequent transfer to the host computer 140. Such operations of the disc drive 100 are well known in the art and are discussed, for example, in U.S. Pat. No. 5,276,662 issued Jan. 4, 1994 to Shaver et al.

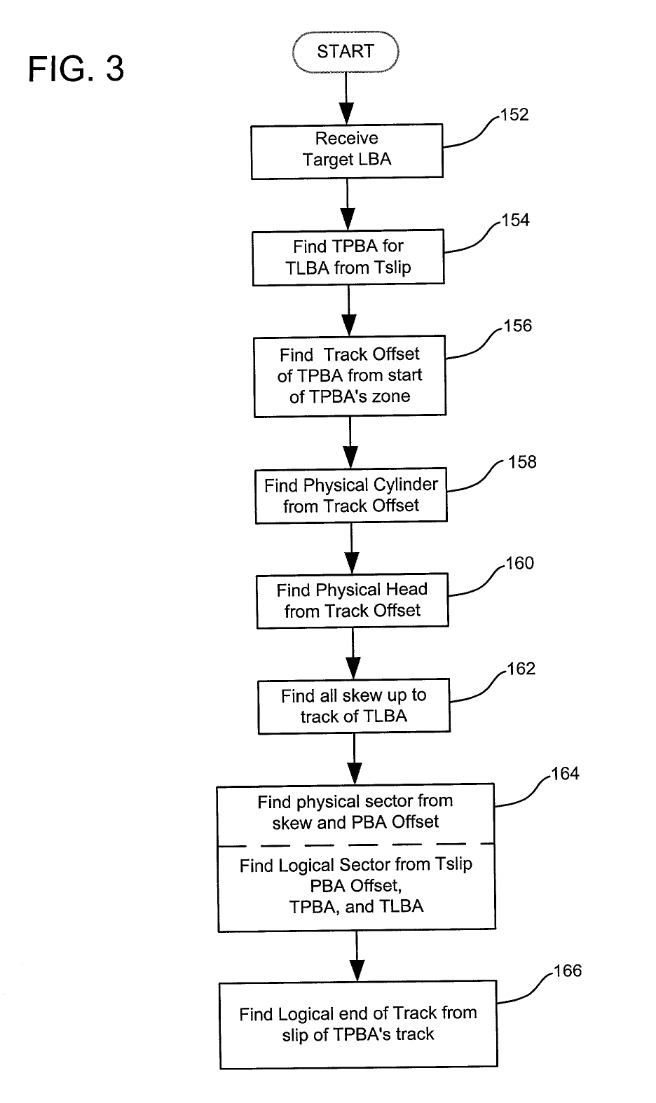

FIG. 3 illustrates the defect management conversion process implemented by the microprocessor 142 for receiving a read or write command from the host 140 and translating a logical block address (LBA) of the command to a physical location on the disc, where the disc has all of the spares pooled at the end of the volume. The LBA may be received directly from the host 140, or it may be determined from a logical cylinder, head, and sector received from the host 140. The defect management conversion process requires accessing information from a defect list and a zone table as explained below.

In the embodiment described below, the next good LBA (NGLBA) located directly after the last defect preceding the received target LBA (TLBA) is accessed from the defect list to find the total number of slips (Tslip) up to the NGLBA. These values may be detected and stored during the certification process. Rather than storing Tslip for each NGLBA entry, Tslip may also be calculated by totaling a count value that may be provided in the defect list for each NGLBA where the count value equals the total span of contiguous defective sectors before the NGLBA. Alternatively, a separate entry may be provided for each defective sector (i.e., count equal to one) and then the number of defective sector entries up to and including the NGLBA entry may be totaled to find Tslip. Other manners of determining Tslip may be possible as well.

The defect conversion process begins at TLBA operation 152 where the disc drive control system of FIG. 2 receives a command and address from the host computer 142. As mentioned the command is either a TLBA or a target logical cylinder, head, and sector that is converted by the microprocessor 142 to a TLBA through conventional processes.

An LBA is an identifier for a sector on a particular track. The disc drive control system of FIG. 2 accounts for defective sectors by mapping them as unusable and not assigning an LBA to the defective sector. The LBAs that are assigned count sequentially from the beginning of the drive to the end while skipping over the defective sectors. The assigned LBAs also account for cylinder seek and head switch skew.

These skews cause the beginning LBA for each track (i.e., the track start LBA or TSLBA) to not necessarily begin at the track start index permanently written to the disc at the same circumferential position for all tracks. Instead, the TSLBA of a given track may be offset from the track start index so that a seek or head switch from the logical end of the preceding track causes the head to arrive just in time to begin reading from or writing to the TSLBA. Otherwise, a partial revolution of the disc may be necessary to cause the TSLBA to return to the head 118 for reading or writing. Skewing the LBAs allows the head to continuously read or write a sequential set of data sectors that span more than one track with a pause in reading or writing occurring only during the actual track seek or head switch, thereby increasing performance.

Once the TLBA is known or received, the process control transitions to TPBA operation 154 where a target physical block address (TPBA) is then determined. The TPBA is another identifier for the same sector as identified by the TLBA. The TPBA, like the TLBA, is a tally for sectors from the beginning of the drive, including the cylinder seek and head switch skew effects, to the target sector, but the TPBA includes a count for each defective sector. Thus, determining the TPBA from the TLBA requires adding the Tslip value for the NGLBA less than the TLBA to the TLBA.

TPBA=TLBA+Tslip

Tslip is found by methods previously described, such as by finding the defect list entry for the NGLBA and then using the Tslip value from that entry. By definition, the number of slipped sectors preceding the NGLBA is the same number of slipped sectors preceding the TLBA.

After the TPBA has been computed, process control transitions to Offset operation 156 where a track offset (i.e., the number of tracks into the zone) of the TPBA's track from the start of the TPBA's zone is calculated. To find this value, the starting PBA for the zone containing the TPBA must be found. The zone containing the TPBA is simply the zone having the greatest zone start PBA (ZSPBA) less than the TPBA. The ZSPBA for a given zone (n) may be in the table or they may be calculated by summing the number of PBAs for each track (PBA_PTRK(i))for a zone multiplied by the number of heads (#Heads) and by the number of cylinders in the zone (CYL_Z(i)) across all of the zones up to zone n. The greatest ZSPBA less than the TPBA equals the zone start of the zone for the TPBA. This value may alternatively be stored in the zone table.

The ZSPBA for a zone (n) is given by

Zone n

Σ [CYL_Z(i)*#Heads*PBA_PTRK(i)]=ZSPBA(n)

0

The number of PBAs from the ZSPBA of the TPBA, (ZOPBA), is then computed by subtracting the ZSPBA for the TPBA from the TPBA.

ZOPBA=TPBA−ZSPBA

Once ZOPBA has been computed, the track offset (TPBA_TZ) or number of tracks into the zone, may be determined. The TPBA_TZ is computed by dividing ZOPBA by the number of PBAs per track (PBA_TRK) for the zone to find an integer portion of a quotient.

TPBA_TZ=Integer Portion (ZOPBA/PBA_TRK)

After TPBA TZ and ZOPBA have been determined, process control transitions to cylinder operation 158 where the physical cylinder for the TLBA is computed. To find the physical cylinder or target cylinder, the cylinder offset into the zone (CylinderZoneOffset) must be found by dividing TPBA_TZ by the number of heads (#Heads) to find an integer portion of the quotient.

CylinderZoneOffset=Integer Portion (TPBA_TZ/#Heads)

Once CylinderZoneOffset is known, the target cylinder may be found by first determining the zone start cylinder (ZSCYL) for the zone. The ZSCYL may be included in the zone table or is calculated by summing the number of cylinders per zone (CYL_Z) up to but not counting the zone of the TPBA.

Zone n−1

Σ [CYL_Z(i)]=ZSCYL

0

Once ZSCYL is known, the target cylinder is found by adding CylinderZoneOffset to the ZSCYL.

Target Cylinder=ZSCYL+CylinderZoneOffset

After finding the target cylinder for the TLBA, process control transitions to head operation 160 where the physical or target head is found. The target head is determined by dividing the TPBA_TZ by #Heads and keeping the remainder of the division (i.e., modulo).

Target Head=Remainder (TPBA_TZ/#Heads) =TPBA_TZ % #Heads

After finding the target head, process control transitions to skew operation 162 where the total skew up to the target zone and the cylinder seek and head switch skews into the target zone are determined. These skews must be accounted for to properly determine the target physical sector address (TPSA) for the TLBA. A physical sector address (PSA) is another identifier for a sector. The PSA may be the value actually read from the sector IDs stored on the magnetic media. The PSA count restarts at the track start index for each track, so skew is not accounted for by the PSA. Also, a PSA is assigned for both good and defective sectors.

Skew may be provided by a register storing the skew value of interest or it may be calculated. To calculate the skew, the cylinder skew for a zone and the head switch skew for a zone must be known, and both are typically stored in the zone table. The cylinder skew for the target zone is then computed by multiplying the target zone cylinder skew (TargetZoneCylSkew) by CylinderZoneOffset.

CylinderSkew=TargetZoneCylSkew*CylinderZoneOffset

The head skew for the target zone is then computed by multiplying the TargetZoneHeadSkew by TargetHead and then adding the #Heads minus two multiplied by the TargetZoneHeadSkew and by CylinderZoneOffset.

HeadSkew=Target ZoneHeadSkew*TargetHead+(#Heads−2)*TargetZoneHeadSkew*CylinderZoneOffset

The total skew up to the target zone (TargetZoneSkew) must also be factored into the TPSA determination and may be found in the zone table. Alternatively, the total skew up to the beginning of the target zone may be calculated by accumulating the head skew per zone and the cylinder skew per zone as follows:

Zone n−1

| | |
|---|---|
| Σ | {[(#Heads − 2) * TargetZoneHeadSkew[i] * CylindersPerZone[i ]]+ |
| 0 | [CylindersPerZone[i] * TargetZoneCylSkew[i]]} * [PBA_PTRK[i]/ |
| | PBA_PTRK[i + 1] |

=TargetZoneSkew

Once all skews that influence the PSA have been calculated, the total skew for the target track can be calculated by summing the skew values, dividing by the PBAs per track for the target track, and keeping the remainder (i.e., modulo).

TotalSkew=(TargetZoneSkew+CylinderSkew+HeadSkew) % PBA_PTRK

Once the total skew is known, process control transitions to sector operation 164 where the TPSA can be computed by adding the total skew to a PBA offset into the target track (TPBA_TO). TPBA_TO is found by keeping the remainder of ZOPBA divided by PBA_TRK (i.e., modulo).

TPBA_TO=Remainder (ZOPBA/PBA_TRK)=ZOPBA % PBA_TRK

The TPSA is then the TPBA_TO offset plus the total skew.

TPSA=TPBA_TO+TotalSkew

It may be desirable to alternatively or additionally compute the target logical sector address (TLSA) for the TLBA at sector operation 164. A logical sector address (LSA) is another identifier for sectors that restarts for each track but accounts for cylinder seek and head switch skews as well as defective sectors. Hardware of some disc drives may be setup to access a physical sector by receiving a logical sector address input along with the physical cylinder and head.

To calculate the TLSA, a starting LBA (TSLBA) for the target track can first be computed from a starting PBA (TSPBA). A TSPBA may be computed by subtracting TPBA_TO from the TPBA, both of which were previously determined.

TSPBA=TPBA−TPBA_TO

The TSPBA may then be computed by adding Tslip to the TSPBA.

TSLBA=TSPBA+Tslip

The TLSA may then be computed by subtracting the TSLBA from the TLBA.

TSLSA=TLBA−TSLBA

At this point the physical location for the TLBA, including the physical cylinder and physical head as well as the physical sector address and/or the logical sector address, is known. The physical location may then be used to properly position the appropriate head 118 over the appropriate cylinder and can begin reading or writing when the data sector corresponding to the physical sector address and/or logical sector address arrives.

After having determined the physical location for the TLBA, it may be useful for process control to transition to LEOT operation 166 where the logical end of the track (LEOT) may be computed. The LEOT value gives the total number of LBAs on the track containing the TLBA. The LEOT value is useful because it allows the disc drive control to determine that the end of the track has been reached and a cylinder seek or head switch is necessary to continue reading or writing.

To determine the LEOT, the total number of slips for the track containing the TLBA must be determined. This may be done by referring to the defect list and finding the greatest NGLBA having a TSLBA equal to that of the TLBA. The defect list may have the TSLBA or it may be calculated as described above. The Tslip value for the greatest NGLBA having a TSLBA equal to the TLBA is then accessed and will be referred to as Tslip_UL. If there is no NGLBA having a TSLBA equal to the TLBA's TSLBA, then the slip for the TLBA's track is equal to zero.

Then, the greatest NGLBA having a TSLBA less than that of the TLBA is found in the defect list, or an NGLBA that is a TLSBA for the track of the TLBA is found if one exists. The Tslip value for this NGLBA is then accessed and will be referred to as Tslip_LL. If there is no NGLBA with a TSLBA less than the TLBA's, then the slip for the TLBA's track is equal to the Tslip_UL. Otherwise, the slip for the TLBA's track (TslipTrk) is equal to Tslip_UL minus Tslip_LL.

TslipTrk=Tslip_UL−Tslip_LL

The LBAs on the TLBA's track (LBA-PTrk) can then be found by subtracting the slip for the TLBA's track from the number of PBAs for the track.

LBA_PTrk=PBA_PTrk−TslipTrk

The LEOT value is simply the LBA_PTrk value. The LEOT value minus one is also equal to the track ending LSA (TELSA) value for the track where the LSA values are zero based. The track ending LBA (TELBA) may additionally be determined if desired by adding the number of LBAs on the track to the TSLBA.

TELBA=TSLBA+LBA_PTrk

Table A below illustrates the various labels as used herein and their correspondence to physical locations on the drive. Table A shows a portion of a first zone for the volume having two cylinders (0 and 1), with two heads (0 and 1) for each cylinder, and with each cylinder containing 8 total sectors for each head. The labels are shown on the left-hand column and the next column indicates the start index for each track of each cylinder. As can be seen, cylinder skew and head skew are accounted for by block addresses and by the logical sector address. For this zone, the cylinder skew is four sectors and the head switch skew is two sectors. Also, as can be seen the block addresses do not restart for each track while the sector addresses do. Also, as can be seen, the logical block addresses and sector addresses account for defects while the physical block addresses and sector addresses do not.

TABLE A

| Cylinder | | | | | | | | |
|---|---|---|---|---|---|---|---|---|
| 0 | | | | | | | | |
| Head 0 | | | | | | | | |
| PSA | 0 | 1 | 2 | 3 | 4 | 5 | 6 | 7 |
| LSA | 0 | 1 | 2 | 3 | 4 | 5 | 6 | 7 |
| PBA | 0 | 1 | 2 | 3 | 4 | 5 | 6 | 7 |
| LBA | 0 | 1 | 2 | 3 | 4 | 5 | 6 | 7 |
| Head 1 | | | | | | | | |
| PSA | 0 | 1 | 2 | 3 | 4 | 5 | 6 | 7 |
| LSA | 5 | 6 | 0 | X | 1 | 2 | 3 | 4 |
| PBA | 14 | 15 | 8 | 9 | 10 | 11 | 12 | 13 |
| LBA | 13 | 14 | 8 | X | 9 | 10 | 11 | 12 |
| Cylinder | | | | | | | | |
| 1 | | | | | | | | |
| Head 0 | | | | | | | | |
| PSA | 0 | 1 | 2 | 3 | 4 | 5 | 6 | 7 |
| LSA | 2 | 3 | 4 | 5 | 6 | 7 | 0 | 1 |
| PBA | 18 | 19 | 20 | 21 | 22 | 23 | 16 | 17 |
| LBA | 17 | 18 | 19 | 20 | 21 | 22 | 15 | 16 |
| Head 1 | | | | | | | | |
| PSA | 0 | 1 | 2 | 3 | 4 | 5 | 6 | 7 |
| LSA | 0 | 1 | X | 2 | 3 | 4 | 5 | 6 |
| PBA | 24 | 25 | 26 | 27 | 28 | 29 | 30 | 31 |
| LBA | 23 | 24 | X | 25 | 26 | 27 | 28 | 29 |

Two defective sectors exist in the portion of the first zone that is shown. The first defect, lies at PSA 3 of cylinder 0 at head 1. The second defect lies at PSA 2 of cylinder 1 at head 1. As is shown, no spares are provided on the track as each sector is used. The defective sectors are logically slipped so that an LBA and an LSA are not assigned to the defective sectors but skip over them.

In the example shown, eight sectors exist per track and eight sectors are used unless a defect exists. In the two tracks where the defects lie, seven sectors remain and are used. Thus, the defect management system accounts for the varying number of sectors per track due to the absence of spare sectors. When reading from or writing to the disc, time may be saved by using all of the non-defective sectors on the track rather than designating one or more as spares. Had spares been allocated for each track, time would be wasted during a read or write when the head would pass over the spares and delaying the reading or writing process until a sector that was not a spare would arrive at the head.

In summary, an aspect of the present invention may be viewed as a method for translating a TLBA value to a physical location value on a data storage disc of a disc drive. The method involves finding a TPBA value corresponding to the TLBA value (such as in operation 154). A track offset value of the TPBA value from a start of a zone containing a TPBA corresponding to the TPBA value is determined (such as in operation 156). A physical cylinder value is computed from the track offset value (such as in operation 158), and a physical head value is computed from the track offset value (such as in operation 160). A total skew value is determined (such as in operation 162) and a PBA offset value of the target PBA value is determined as well (such as in operation 164). After determining the total skew, a physical sector value is computed from the total skew value (such as in operation 164) as well as from the PBA offset value that was also determined.

The method may further involve finding a TSLBA value for the TLBA value and computing a logical sector value from the TSLBA value and the TLBA value (such as in operation 164). The method may involve finding a defect list entry that provides a number of slips up to a TLBA corresponding to the TLBA value and adding the number of slips up to the TLBA to the TLBA value to find the TPBA value (such as in operation 154).

The method may also involve calculating a ZSPBA value and reducing the TPBA value by the ZSPBA value to find a number of PBAs from a zone start PBA corresponding to the ZSPBA value to the TPBA (such as in operation 156). The method may further involve scaling the number of PBAs from the ZSPBA by a number of PBAs per track within a zone containing the TPBA and using an integer portion of a quotient determined by scaling step as the track offset value (such as in operation 156).

The method may also involve scaling the track offset value by the number of heads and using an integer portion of a quotient determined at this scaling step as the physical cylinder value (such as in operation 158). The method may also involve using a remainder of this scaling step as the physical head value (such as in operation 160). The method may also include using a remainder of this scaling step as the PBA offset (such as in operation 164).

The method may also include finding a first skew value including all skew up to a zone containing the TPBA, finding a skew second skew value including all skew within the zone containing the TPBA, and moduloing a sum of the first skew value and the second skew value by the number of PBAs per track to find the total skew value (such as in operation 164). The method may further include summing the total skew value and the PBA offset to find the physical sector value (such as in operation 164). The method may also include computing a LEOT containing the TLBA by finding the number of slips on the track and deducting the number of slips on the track from the number of PBAs on the track (such as in operation 166).

Another aspect of the present invention may be viewed as a disc drive that translates a TLBA value to a physical location value on a data storage disc. The disc drive includes an interface (such as interface 144) for receiving a command from a host computer (such as host 140). The disc drive further includes a processor (such as microprocessor 142) configured to find a TPBA for the command, determine a track offset value of the TPBA value from a start of a zone containing a TPBA corresponding to the TPBA value, compute a physical cylinder value and a head value from the track offset value, find a TSLBA value for the TPBA value, and compute a logical sector value from the TSLBA value and the TLBA value.

In the disc drive, the processor (such as microprocessor 142) may further be configured to determine a total skew value and a PBA offset value of the TPBA value, and compute a physical sector value from the total skew value and the PBA offset value. In the disc drive, the processor (such as microprocessor 142) may be further configured to determine a total skew value by finding a first skew value up including all skew up to a zone containing the TPBA, finding a skew second skew value including all skew within the zone containing the TPBA, and moduloing a sum of the first skew value and the second skew value by the number of PBAs per track to find the total skew value.

In the disc drive, the processor may also be further configured to find the physical sector value by summing the total skew value and the PBA offset. The disc drive may further include a memory (such as memory 143) containing a defect list, and the processor (such as processor 142) may be further configured to find the TPBA by finding a defect list entry that provides a number of slips up to a TLBA corresponding to a TLBA value contained in the command and adding the number of slips up to the TLBA to the TLBA value to find the TPBA value.

In the disc drive, the processor (such as microprocessor 142) may be further configured to determine a number of PBAs from a ZSPBA to the TPBA by calculating a ZSPBA value corresponding to the ZSPBA and reducing the TPBA value by the ZSPBA value. In the disc drive, the processor (such as microprocessor 142) may be further configured to scale the number of PBAs from the ZSPBA by a number of PBAs per track within a zone containing the TPBA and use an integer portion of a quotient resulting from the scaling as the track offset value. In the disc drive, the processor (such as microprocessor 142) may be further configured to scale the track offset value by the number of heads, use an integer portion of a quotient of the scaled track offset as the physical cylinder value, and use a remainder of the scaled track offset as the physical head value.

It will be clear that the present invention is well adapted to attain the ends and advantages mentioned as well as those inherent therein. While a presently preferred embodiment has been described for purposes of this disclosure, various changes and modifications may be made which are well within the scope of the present invention. For example, various values computed above may be included in the defect list or the zone table such as the starting PBA for a zone, the total skew up to the beginning of a zone, and the TSLBA for a defect entry. Furthermore, entries for completely defective tracks could be added to the defect list and used to offset the cylinder calculations. Additionally, the logical address to physical location conversion process may be employed with track-based or seamless sparing schemes. Numerous other changes may be made which will readily suggest themselves to those skilled in the art and which are encompassed in the spirit of the invention disclosed and as defined in the appended claims.

What is claimed is:

1. A method for translating a target logic block address (TLBA) value to a physical location value on a data storage disc of a disc drive, comprising steps of:
a) finding a target physical block address (TPBA) value corresponding to the TLBA value;
b) determining a track offset value of the TPBA value from a start of a zone on the disc containing a TPBA corresponding to the TPBA value;
c) computing a physical cylinder value and a head value from the track offset value;
d) determining a total skew value and a PBA (physical block address) offset value of the TPBA value; and
e) computing a physical sector value from the total skew value and the PBA offset value.

2. The method of claim 1, further comprising steps of:
f) finding a track start logical block address (TSLBA) value for the TLBA value; and
g) computing a logical sector value from the TSLBA value and the TLBA value.

3. The method of claim 1, wherein a defect list is maintained by the disc drive and the finding step a) comprises steps of:
a)(i) finding a defect list entry that provides a number of slips up to a TLBA corresponding to the TLBA value; and
a)(ii) adding the number of slips up to the TLBA to the TLBA value to find the TPBA value.

4. The method of claim 1, wherein the determining step b) comprises steps of:
b)(i) calculating a zone start PBA (ZSPBA) value; and
b)(ii) reducing the TPBA value by the ZSPBA value to find a number of PBAs from a ZSPBA corresponding to the ZSPBA value to the TPBA.

5. The method of claim 4, wherein the computing step c) comprises steps of:
c)(i) scaling the number of PBAs from the ZSPBA by a number of PBAs per track within a zone containing the TPBA; and
c)(ii) using an integer portion of a quotient determined in scaling step c)(i) as the track offset value.

6. The method of claim 5, wherein the computing step c) further comprises steps of:
c)(iii) scaling the track offset value by a number of heads; and
c)(iv) using an integer portion of a quotient determined in scaling step c)(iii) as the physical cylinder value.

7. The method of claim 6, wherein the computing step c) further comprises steps of:
c)(v) using a remainder of scaling step c)(iii) as the physical head value.

8. The method of claim 5, wherein the determining step d) comprises a step d)(i) of using a remainder of scaling step c)(i) as the PBA offset.

9. The method of claim 1, wherein the determining step d) comprises steps of:
d)(ii) finding a first skew value including all skew up to a zone containing the TPBA;
d)(iii) finding a second skew value including all skew within the zone containing the TPBA; and
d)(iv) moduloing a sum of the first skew value and the second skew value by the number of PBAs per track to find the total skew value.

10. The method of claim 9, wherein the computing step e) comprises a step (e)(i) of summing the total skew value and the PBA offset to find the physical sector value.

11. The method of claim 1, further comprising a step h) of computing a logical end of the track (LEOT) containing the TLBA by finding a number of slips on the track and deducting the number of slips on the track from the number of PBAs on the track.

12. A disc drive that translates a TLBA value to a physical location value on a data storage disc, comprising:
an interface for receiving a command from a host computer;
a processor configured to find a TPBA for the command, determine a track offset value of the TPBA value from a start of a zone on the disc containing a TPBA corresponding to the TPBA value, compute a physical cylinder value and a head value from the track offset value, find a TSLBA value for the TPBA value, and compute a logical sector value from the TSLBA value and the TLBA value.

13. The disc drive of claim 12, wherein the processor is further configured to determine a total skew value and a PBA offset value of the TPBA value, and compute a physical sector value from the total skew value and the PBA offset value.

14. The disc drive of claim 13, wherein the processor is further configured to determine a total skew value by finding a first skew value including all skew up to a zone containing the TPBA, find a second skew value including all skew within the zone containing the TPBA, and modulo a sum of the first skew value and the second skew value by the number of PBAs per track to find the total skew value.

15. The disc drive of claim 14, wherein the processor is further configured to find the physical sector value by summing the total skew value and the PBA offset.

16. The disc drive of claim 12, wherein the disc drive further comprises a memory containing a defect list, and wherein the processor is further configured to find the TPBA by finding a defect list entry that provides a number of slips up to a TLBA corresponding to a TLBA value contained in the command and adding the number of slips up to the TLBA to the TLBA value to find the TPBA value.

17. The disc drive of claim 12, wherein the processor is further configured to determine a number of PBAs from a ZSPBA to the TPBA by calculating a ZSPBA value corresponding to the ZSPBA and reducing the TPBA value by the ZSPBA value.

18. The disc drive of claim 17, wherein the processor is further configured to scale the number of PBAs from the ZSPBA by a number of PBAs per track within a zone containing the TPBA and use an integer portion of a quotient resulting from the scaling as the track offset value.

19. The disc drive of claim 18, wherein the processor is further configured to scale the track offset value by a number of heads, use an integer portion of a quotient of the scaled track offset as the physical cylinder value, and use a remainder of the scaled track offset as the physical head value.

20. A disc drive that stores information on a data storage disc having physical locations, comprising:
an interface that receives a command; and
a processing means for converting a logical location value from the command to a physical location value.
